(19) United States
(12) Patent Application Publication
(10) Pub. No.: US 2005/0201786 A1
(43) Pub. Date: Sep. 15, 2005

(54) Sheet processing apparatus, automatic document feeder and image forming apparatus

(76) Inventor: Takuya Ito, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 10/995,242

(22) Filed: Nov. 24, 2004

(30) Foreign Application Priority Data
Nov. 27, 2003 (JP) P. 2003-396857

(51) Int. Cl. G03G 15/00

(52) U.S. Cl. 399/367

(57) ABSTRACT

In a sheet processing apparatus that includes an acting portion to exert an action on a sheet, and at least one of first and second carrying devices, the first carrying device is arranged on a downstream side of the acting portion and a lead edge of the sheet enters the first carrying device during the action of the acting portion, the second carrying device is arranged on an upstream side of the acting portion, and the sheet exits from the second carrying device during the action of the acting portion, at least one of the first and second carrying devices has a driving roller and a driven roller, and the sheet is put between the driving roller and the driven roller and is carried, and a Shore hardness Hs of at least a surface portion of the driven roller based on ISO7619 is set in a range of 20 to 50 degree.

### BACKGROUND OF THE INVENTION

1. Field of the Invention

The present invention relates to a sheet processing apparatus, an automatic document feeder, and an image forming apparatus.

2. Description of the Related Art

In the image forming apparatus, for example, there is an automatic document feeder as one of sheet processing apparatuses. This type automatic document feeder includes a reading portion to read an image of a sheet as the document, and a carrying device to carry the sheet to this reading portion. In the prior art, as this type automatic document feeder, the feeder of the type that the image of the document is fed to be read by the fixed reading portion is known. In recent years, diversification of the paper quality and coloring make striking progress, and the market needs for read picture quality are increased more and more. Therefore, in this type automatic document feeder, it is necessary to execute the optimization of a motor rotation precision, a carrying path, etc. since the good picture quality can be ensured by carrying the document at a constant carrying speed during the image reading operation.

However, the truth of the matter is that the carrying speed is varied during the carrying operation of the document by various factors. In order to improve such variation, several technologies have been already proposed. In JP-A-8-30044, such a technology has been disclosed that the belt carrying mechanism is provided on the top portion of the reading portion and then the document is pushed by the belt member of the belt carrying mechanism to prevent the variation of the carrying speed of the document while the document is carried. Also, in JP-2003-189069, such a technology has been disclosed that the carrying position of the document is kept horizontally by providing plural platen rollers on the top portion of the reading portion and thus a precision of the document reading position is maintained.

However, in JP-A-8-30044 and JP-2003-189069, the variation of the carrying speed caused in transferring the sheet (document) between the carrying devices or in pulling out the sheet from the carrying device is not disclosed at all. In particular, the large variation of the carrying speed is caused in transferring the thick paper between the carrying devices or in pulling out the thick paper from the carrying device.

### SUMMARY OF THE INVENTION

A first aspect of the present resides in that a sheet processing apparatus includes an acting portion to exert an action on a sheet, and at least one of a first carrying device and a second carrying device, wherein the first carrying device is arranged on a downstream side of the acting portion, and a lead edge of the sheet enters the first carrying device during the action of the acting portion, the second carrying device is arranged on an upstream side of the acting portion, and the sheet exits from the second carrying device during the action of the acting portion, at least one of the first carrying device and the second carrying device has a driving roller and a driven roller, and the sheet is put between the driving roller and the driven roller and is carried, and a Shore hardness Hs of at least a surface portion of the driven roller based on ISO7619 (Durometer type A, same as JIS K6253) is set in a range of 20 to 50 degree. Here, the sheet contains a document sheet and a recording sheet, and the material contains a paper and an OHP film. According to the present invention, the Shore hardness Hs of at least a surface portion of the driven roller based on ISO7619 is set in a range of 20 to 50 degree, and is set lower than the normal hardness (60 to 90 degree) of the driven roller. Therefore, the sheet can be inserted into a nip portion, in which the driving roller and the driven roller face to each other, by a small force and the variation of the carrying speed of the sheet can be reduced.

A second aspect of the present resides in that a sheet processing apparatus includes an acting portion to exert an action on a sheet, and at least one of a first carrying device and a second carrying device, wherein the first carrying device is arranged on a downstream side of the acting portion, and a lead edge of the sheet enters the first carrying device during the action of the acting portion, the second carrying device is arranged on an upstream side of the acting portion, and the sheet exits from the second carrying device during the action of the acting portion, at least one of the first carrying device and the second carrying device has a driving roller and a driven roller, and the sheet is put between the driving roller and the driven roller and is carried, and a hardness of at least a surface portion of the driven roller is lower than a hardness of at least a surface portion of the driving roller. According to the present invention, since the surface portion of the driven roller is set softer than the surface portion of the driving roller, the sheet can be inserted into a nip portion, in which the driving roller and the driven roller face to each other, by a small force and the variation of the carrying speed of the sheet can be reduced. In contrast, since the surface portion of the driving roller is set harder than the surface portion of the driven roller, the sheet can be inserted into a nip portion, the wear of the driving roller can be kept small, and a slip of the sheet can be reduced, and thus it can be prevented that the carrying speed is varied gradually by the wear.

It is preferable that the Shore hardness Hs of the surface portion of the driving roller based on ISO7619 is set in a range of 60 to 90 degree, and the Shore hardness Hs of the surface portion of the driven roller based on ISO7619 is set in a range of 20 to 50 degree. Also, it is preferable that constitutive materials of the surface portion of the driving roller and the surface portion of the driven roller are different. This is because, if the constitutive materials of the surface portion of the driving roller and the surface portion of the driven roller are identical and also the surface portion of the driving roller is formed of oil-rich material, for example, such faults may be caused that the oil is transferred to the surface portion of the driven roller to inflate the driven roller, and the like.

A third aspect of the present resides in that an image forming apparatus includes a sheet processing apparatus, wherein the sheet processing apparatus includes an acting portion to exert an action on a sheet, and at least one of a first carrying device and a second carrying device, wherein the first carrying device is arranged on a downstream side of the acting portion, and a lead edge of the sheet enters the first carrying device during the action of the acting portion, the second carrying device is arranged on an upstream side of the acting portion, and the sheet exits from the second carrying device during the action of the acting portion, at least one of the first carrying device and the second carrying device has a driving roller and a driven roller, and the sheet is put between the driving roller and the driven roller and is carried, and a Shore hardness Hs of at least a surface portion of the driven roller based on ISO7619 is set in a range of 20 to 50 degree.

A fourth aspect of the present resides in that an image forming apparatus includes a sheet processing apparatus, wherein the sheet processing apparatus includes an acting portion to exert an action on a sheet, and at least one of a first carrying device and a second carrying device, wherein the first carrying device is arranged on a downstream side of the acting portion, and a lead edge of the sheet enters the first carrying device during the action of the acting portion, the second carrying device is arranged on an upstream side of the acting portion, and the sheet exits from the second carrying device during the action of the acting portion, at least one of the first carrying device and the second carrying device has a driving roller and a driven roller, and the sheet is put between the driving roller and the driven roller and is carried, and a hardness of at least a surface portion of the driven roller is lower than a hardness of at least a surface portion of the driving roller.

A fifth aspect of the present resides in that an automatic document feeder includes a reading portion to read an image of a document, a first carrying device which is arranged on an upstream side of the reading portion and out of which the document slips while the reading portion reads the image of the document, and a second carrying device which is arranged on a downstream side of the reading portion and against which the document hits while the reading portion reads the image of the document, wherein at least one of the first carrying device and the second carrying device has a driving roller and a driven roller, and the document is put between the driving roller and the driven roller and is carried, and a Shore hardness Hs of at least a surface portion of the driven roller based on ISO7619 is set in a range of 20 to 50 degree. According to the present invention, the Shore hardness Hs of at least a surface portion of the driven roller based on ISO7619 is set in a range of 20 to 50 degree, and is set lower than the normal hardness (60 to 90 degree) of the driven roller. Therefore, the sheet can be pulled out from the nip portion, in which the driving roller and the driven roller face to each other, by a small force, and the variation of the carrying speed of the sheet can be reduced, and thus the picture quality of the read image can be improved.

A sixth aspect of the present resides in that an automatic document feeder includes a reading portion to read an image of a document, a first carrying device which is arranged on an upstream side of the reading portion and out of which the document slips while the reading portion reads the image of the document, and a second carrying device which is arranged on a downstream side of the reading portion and against which the document hits while the reading portion reads the image of the document, wherein at least one of the first carrying device and the second carrying device has a driving roller and a driven roller, and the document is put between the driving roller and the driven roller and is carried, and a hardness of at least a surface portion of the driven roller is lower than a hardness of at least a surface portion of the driving roller. According to the present invention, since the surface portion of the driven roller is set softer than the surface portion of the driving roller, the sheet can be pulled out from the nip portion, in which the driving roller and the driven roller face to each other, by a small force and the variation of the carrying speed of the sheet can be reduced, and thus the picture quality of the read image can be improved. In contrast, since the surface portion of the driving roller is set harder than the surface portion of the driven roller, the sheet can be inserted into a nip portion, the wear of the driving roller can be kept small, and a slip of the sheet can be reduced, and thus it can be prevented that the carrying speed is varied gradually by the wear, and thus it can be prevented that the picture quality of the read image is worsened.

Similarly, in the automatic document feeder, it is preferable that the Shore hardness Hs of the surface portion of the driving roller based on ISO7619 is set in a range of 60 to 90 degree, and the Shore hardness Hs of the surface portion of the driven roller based on ISO7619 is set in a range of 20 to 50 degree. Also, it is preferable that constitutive materials of the surface portion of the driving roller and the surface portion of the driven roller are different. Also, it is preferable that a guide member to guide the document is provided in vicinity of a nip portion in which the driving roller and the driven roller face to each other, and the guide member is formed of a sheet-like elastic body. The document can be guided smoothly to the nip portion by the guide member. Also, it is preferable that the automatic document feeder further includes a first driving source to drive the first carrying device, and a second driving source provided separately from the first driving source, to drive the second carrying device. Since the first driving source and the second driving source are provided separately, it is made easily to control separately the first drive roller and the second drive roller.

A seventh aspect of the present resides in that an image forming apparatus including an automatic document feeder, wherein the automatic document feeder includes a reading portion to read an image of a document, a first carrying device which is arranged on an upstream side of the reading portion and out of which the document slips while the reading portion reads the image of the document, and a second carrying device which is arranged on a downstream side of the reading portion and against which the document hits while the reading portion reads the image of the document, wherein at least one of the first carrying device and the second carrying device has a driving roller and a driven roller, and the document is put between the driving roller and the driven roller and is carried, and a Shore hardness Hs of at least a surface portion of the driven roller based on ISO7619 is set in a range of 20 to 50 degree.

An eighth aspect of the present resides in that an image forming apparatus including an automatic document feeder, wherein the automatic document feeder includes a reading portion to read an image of a document, a first carrying device which is arranged on an upstream side of the reading portion and out of which the document slips while the reading portion reads the image of the document, and a second carrying device which is arranged on a downstream side of the reading portion and against which the document hits while the reading portion reads the image of the document, wherein at least one of the first carrying device and the second carrying device has a driving roller and a driven roller, and the document is put between the driving roller and the driven roller and is carried, and a hardness of at least a surface portion of the driven roller is lower than a hardness of at least a surface portion of the driving roller.

A ninth aspect of the present resides in that an image forming apparatus includes an image bearing member, a transferring device to transfer an image borne on the image bearing member onto a sheet, and a carrying device which is arranged on an upstream side of the transferring device and out of which the sheet slips while the transferring device transfers the image, wherein the carrying device has a driving roller and a driven roller, and the sheet is put between the driving roller and the driven roller and is carried, and a Shore hardness Hs of at least a surface portion of the driven roller based on ISO7619 is set in a range of 20 to 50 degree. According to the present invention, the Shore hardness Hs of at least a surface portion of the driven roller based on ISO7619 is set in a range of 20 to 50 degree, and is set lower than the normal hardness (60 to 90 degree) of the driven roller. Therefore, the sheet can be pulled out from the nip portion, in which the driving roller and the driven roller face to each other, by a small force, and the variation of the carrying speed of the sheet can be reduced, and thus the picture quality of the read image can be improved.

A tenth aspect of the present resides in that an image forming apparatus includes an image bearing member, a transferring device to transfer an image borne on the image bearing member onto a sheet, and a carrying device which is arranged on an upstream side of the transferring device and out of which the sheet slips while the transferring device transfers the image, wherein the carrying device has a driving roller and a driven roller, and the sheet is put between the driving roller and the driven roller and is carried, and a hardness of at least a surface portion of the driven roller is lower than a hardness of at least a surface portion of the driving roller. According to the present invention, since the surface portion of the driven roller is set softer than the surface portion of the driving roller, the sheet can be pulled out from the nip portion, in which the driving roller and the driven roller face to each other, by a small force and the variation of the carrying speed of the sheet can be reduced, and thus the picture quality of the read image can be improved. In contrast, since the surface portion of the driving roller is set harder than the surface portion of the driven roller, the sheet can be inserted into a nip portion, the wear of the driving roller can be kept small, and a slip of the sheet can be reduced, and thus it can be prevented that the carrying speed is varied gradually by the wear, and thus it can be prevented that the picture quality of the read image is worsened.

### BRIEF DESCRIPTION OF THE DRAWINGS

Preferred embodiments of the present invention will be described in detail based on the following figures, wherein:

FIG. 1 is a side view showing an image forming apparatus according to an embodiment of the present invention;

FIG. 2 is a side view showing an automatic document feeder according to the embodiment of the present invention;

FIG. 3 is a sectional view showing a carrying apparatus employed in the automatic document feeder according to the embodiment of the present invention;

FIG. 4 is a table showing combinations of material of a driving roller and a material of a driven roller according to the embodiment of the present invention;

FIG. 5 is a perspective view showing an example of the driven roller employed in the carrying apparatus according to the embodiment of the present invention;

FIG. 6 is a perspective view showing another example of the driven roller employed in the carrying apparatus according to the embodiment of the present invention; and

FIG. 7 is a side view showing another embodiment of the present invention.

### DETAILED DESCRIPTION OF THE INVENTION

Embodiments of the present invention will be explained hereinafter.

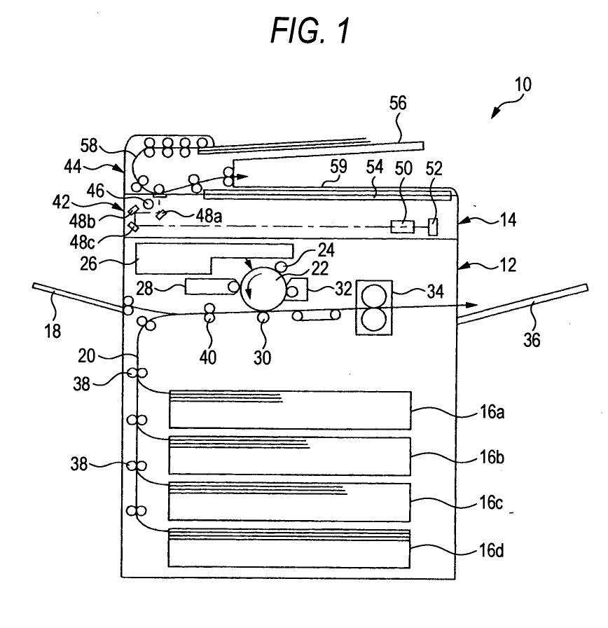

In FIG. 1, an outline of an image forming apparatus 10 is shown. The image forming apparatus 10 includes an image forming portion 12 and a document reading apparatus 14. The image forming portion 12 is of xerography type, for example, and has four-layered paper feed trays 16a, 16b, 16c, 16d and a manual-bypass tray 18. The image is formed on the sheet that is supplied from one of these trays 16a to 16d, 18 to a sheet carrying path 20.

More particularly, the image forming portion 12 has a photoreceptor 22 serving as an image bearing member, a charging device 24 to charge the photoreceptor 22 uniformly, an exposing device 26 to form a latent image on the photoreceptor 22 that was charged uniformly by the charging device 24, a developing device 28 to visualize the latent image formed on the photoreceptor 22 by the exposing device 26 with toners, a transferring device 30 to transfer a toner image formed by the developing device 28 onto the sheet, and a cleaner 32 to clean the toners that are remained on the photoreceptor 22. The exposing device 26 is of laser scanning type, for example, and converts the image of the document read by a reading sensor 52 of the image forming apparatus 10, described later, into an ON/OFF signal of a laser and then outputs the signal. The transferring device 30 is composed of a transfer roller, for example. The sheet onto which the toner image is transferred by this transferring device 30 is fed to a fixing device 34, then the toner image is fixed onto the sheet by the fixing device 34, and then the sheet onto which the toner image is fixed is discharged to a discharge tray 36.

Plural sheet carrying rollers 38 are provided in the sheet carrying path 20. As one of these sheet carrying rollers 38, a registration roller 40 is arranged in vicinity of the transferring device 30 on the upstream side. The registration roller 40 is controlled to stop temporarily the fed sheet and feed the sheet to the transferring device 30 in synchronism with a timing at which the latent image is formed on photoreceptor 22.

The document reading apparatus 14 includes an optical system 42 to read the document optically, and an automatic document feeder 44.

The optical system 42 has a lamp 46 to irradiate a light onto the document, reflecting mirrors 48a, 48b, 48c to reflect the light from the document, a lens 50 to converge the light from the reflecting mirrors 48a, 48b, 48c, and a reading sensor 52 to read the light that is converged by the lens 50. The reading sensor 52 is composed of a CCD, for example. The optical system 42 has a function of reading through the document, which is fed from the automatic document feeder 44 described later, by the reading portion that is fixed around end portions of the reflecting mirrors 48a to 48c, and a function of reading the document loaded on an original glass plate 54 by scanning the reflecting mirrors 48a, 48b, 48c, etc.

The automatic document feeder 44 has an original table 56 on which a number of documents are put, a document carrying path 58 to carry the document, and a discharge table 59 onto which the document is discharged after the image is read from the document.

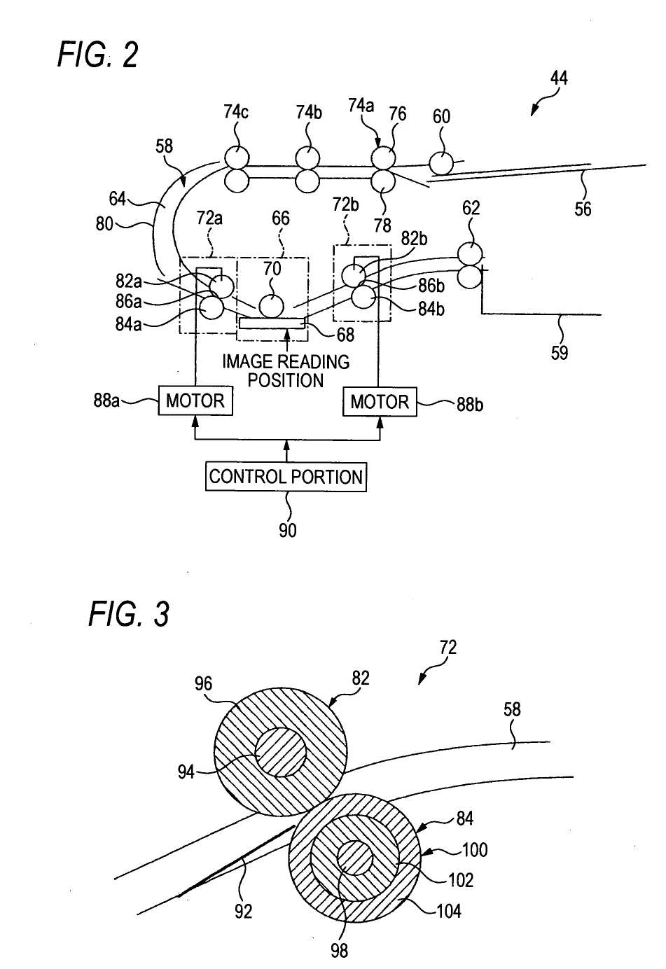

In FIG. 2, details of the automatic document feeder 44 are shown. The document carrying path 58 is a path that is extended from a pick-up roller 60, which picks up the document loaded on the original table 56, to a discharge roller 62 that discharges the document onto the discharge table 59, and has a turning portion 64 formed like a U-shape. A reading portion 66 is provided on the downstream side of the turning portion 64 in the document carrying path 58. This document carrying path 58 consists of a platen glass 68, and a read roller 70 to push the document against the platen glass 68. An image reading position is provided in vicinity of a contact portion between the platen glass 68 and the read roller 70 on the downstream side. Also, a first carrying device 72a is provided on the upstream side of the reading portion 66, and a second carrying device 72b is provided on the downstream side thereof. Also, three carrying devices 74a, 74b, 74c, for example, are provided on the upstream side of the turning portion 64. The carrying device 74a is positioned on the downstream side of the pick-up roller 60 and is constructed as a handling device that handles the document that is carried from the pick-up roller 60. In other words, the carrying device 74a is composed of a feed roller 76 and a retard roller 78, and handles the document by the cooperation of the feed roller 76 and the retard roller 78 to feed only the uppermost document.

Also, a guide 80 is positioned on the outside of the turning portion 64 to swing on the neighborhood of the carrying device 74c as a fulcrum. When the lead edge of the sheet fed from the carrying devices 74a to 74c enters the first carrying device 72a, this guide 80 swings outwardly due to a rigidity of the document to adjust an amount of deflection of the document.

The first carrying device 72a is composed of a first drive roller 82a and a first driven roller 84a. The document is put between a first nip portion 86a formed by the first drive roller 82a and the first driven roller 84a to carry. In this embodiment, the first carrying device 72a is constructed as the registration roller, then stops or rotates reversely when the document is fed from the carrying devices 74a to 74c. Thus, since the document that is fed obliquely comes into contact with the first drive roller 82a or the first driven roller 84a, a skew correction is applied to position the document perpendicularly to the carrying direction. The document comes out of the first nip portion 86a of the first carrying device 72a while the image is read by the reading portion 66.

Similarly, the second carrying device 72b is composed of a second drive roller 82b and a second driven roller 84b. The document is put between a second nip portion 86b consisting of the second drive roller 82b and the second driven roller 84b to carry. The document contacts the second carrying device 72b in the vicinity of the second nip portion 86b while the reading portion 66 is reading the image. Then, the document is inserted forcedly into the second nip portion 86b.

The first and second drive roller 82a, 82b are coupled to separate motors 88a, 88b respectively. The first and second motors 88a, 88b are controlled separately by a control portion 90 respectively.

In this embodiment, the first carrying device 72a and the second carrying device 72b have the same configuration. For this reason, in FIG. 3 to FIG. 5, each of these first and second carrying devices 72a, 72b is denoted as a carrying device 72 by omitting its subscript and thus their explanation will be omitted herein.

In FIG. 3, in the carrying apparatus 72, a guiding member 92 made of a thin elastic member such as a Mylar film, or the like, for example, is arranged in vicinity of a nip portion 86 on the upstream side. The carrying apparatus 72 is constructed such that this guiding member 92 can carry smoothly the document toward the nip portion 86.

A drive roller 82 is composed of a driving shaft 94, and a main body portion (surface portion) 96 fixed around the driving shaft 94. The main body portion 96 is rotated integrally with the driving shaft 94. The main body portion 96 is provided to plural locations at a predetermined interval in the axial direction of the driving shaft 94. Also, the main body portion 96 is formed of an elastic material such as ethylene propylene diene methylene linkage (hereinafter, abbreviated to EPDM) type material, urethane type material, or the like. The main body portion 96 has a Shore hardness Hs based on ISO7619 in a range of 60 to 90 degree. It is preferable that the hardness is in a range of 60 to 80 degree.

In contrast, a driven roller 84 is composed of a driven shaft 98, and a main body portion 100 provided rotatably around the driven shaft 98. The main body portion 100 consists of a sliding receiving member 102, and a surface portion 104 fixed around the sliding receiving member 102. The main body portion 100 is provided to plural locations at a predetermined interval in the axial direction of the driving shaft 94. In this embodiment, as shown in FIG. 5, the driven shaft 98 is fixed to the main body portion of the automatic document feeder, and then the main body portion 100 is supported rotatably onto this fixed driven shaft 98 in such a manner that this main body portion 100 can be rotated together with the rotation of the drive roller 82. The sliding receiving member 102 is made of polyoxymethylene (hereinafter, abbreviated to POM), for example. Also, the surface portion 104 is formed of elastic material such as EPDM type material, urethane type material, silicone, or the like. The surface portion 104 has ashore hardness Hs based on ISO7619 in a range of 20 to 50 degree. It is preferable that the hardness is in a range of 20 to 40 degree.

Therefore, when the hardness of the surface portion 96 of the drive roller 82 and the hardness of the surface portion 104 of the driven roller 84 are compared with each other, the hardness of the surface portion 104 of the driven roller 84 is lower than the hardness of the surface portion 96 of the drive roller 82. In this case, even though the roller materials belong to the same type of material, the hardness can be adjusted by varying components contained in the roller.

Next, experimental results showing the influence of the hardness of the driven roller 84 on a variation in the speed of the document are given in Table 1. In the experiment, the rollers each having the different hardness were mounted on the second driven roller 84b, and then the variation of the carrying speed of the document was examined when a lead edge of the document arrived at the second driven roller 84b. The driven roller whose material is the EPDM type material and whose Shore hardness is in a range of 30 Hs to 70 Hs based on ISO7619 was prepared for the experiment. Also, as the comparative example, the driven roller that is made of the highly slidable POM resin having the hardness of 80 to 100 (Rockwell hardness) was prepared for the experiment. The roller of 14 mm diameter was used as both driven rollers. The experimental examples in which the carrying speed of the document is set to 220 mm/sec were given in Table 1. But the similar results were obtained in 110 mm/sec, 330 mm/sec, and 440 mm/sec.

TABLE 1

| | Hardness | Speed variation | |
|---|---|---|---|
| Material | (Hs) | (%) | Image defect |
| POM | | 18.0 | LARGE |
| EPDM | 70 | 14.0 | LARGE |
| EPDM | 60 | 12.0 | MEDIUM |
| EPDM | 50 | 8.0 | SMALL |
| EPDM | 40 | 5.0 | SMALL |
| EPDM | 30 | 3.0 | TINY |

Normally, when the variation of the carrying speed exceeds 5% in reading the carried document, recognizing that the image defect is present in the image, which was obtained by rendering read data of the document visible, is started. Then, when the variation of the carrying speed exceeds 10% or so, the image defect is conspicuous. Therefore, the hardness of the driven roller should be set preferably to 60 Hs or less, more preferably 50 Hs or less, and most preferably 40 Hs or less.

Meanwhile, normally the rubber material whose hardness is below 20 Hs is poor in the wear resistance, and faults are easily caused such that the permanent strain is ready to occur, and the like. Therefore, it is requested to adopt various measures such that a pushing force, a roller width, and a rubber thickness must be adjusted properly, a pushing means must be released in case such rubber material is exposed to the high-temperature environment during the transportation, and the like. As a result, it is preferable that, in case the wear resistance and the preservation of the roller shape are looked up as important, the material having the hardness of 20 Hs or more should be employed.

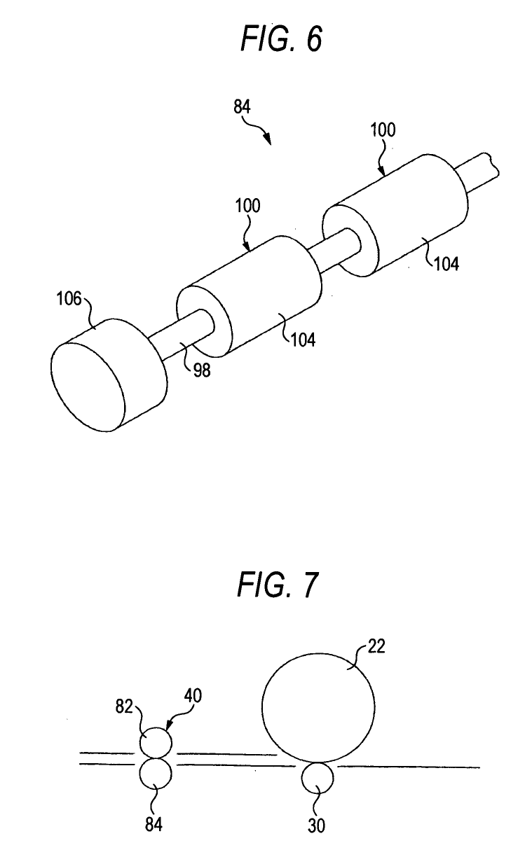

In this case, as shown in FIG. 6, as another example of the driven roller 84, the main body portion 100 may be constructed by fixing directly the surface portion 104 to the driven shaft 98, and this driven shaft 98 may be supported by a bearing 106 that is provided to the main body portion of the automatic document feeder, and thus the main body portion 100 may be rotated integrally with the driven shaft 98.

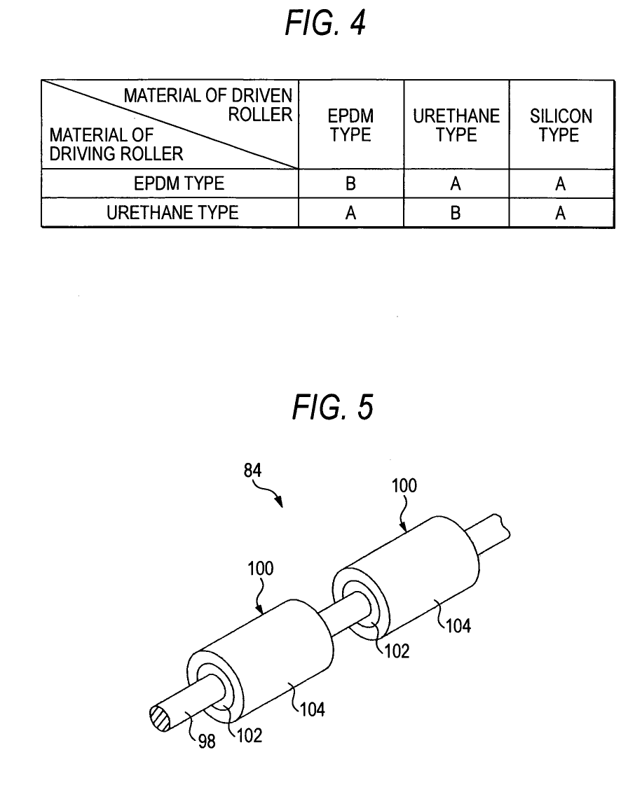

In FIG. 4, combinations of the material of the driving roller and the material of the driven roller are shown as a table. Although each of all combinations can be employed, preferably the material of the driving roller and the material of the driven roller should be chosen differently, as indicated by A. This is because it is possible that the faults such that the oil is transferred onto the surface portion of the driven roller to inflate the driven roller, and the like will be caused if the EPDM type material or the urethane-type material is chosen mutually, as indicated by B, and also the surface portion of the driving roller is formed of the oil-rich material, for example.

Next, an operation of the automatic document feeder 44 according to the above embodiment will be explained hereunder.

First, the document set on the original table 56 is picked up by the pick-up roller 60, then handled by the feed roller 76 and the retard roller 78 of the carrying device 74a, and then carried by the carrying devices 74b, 74c along the document carrying path 58. Thus, a lead edge of the document enters the first carrying device 72a. At this time, the first motor 88a is controlled by a command issued from the control portion 90 in such a manner that the first drive roller 82a of the first carrying device 72a is stopped or the first drive roller 82a is rotated reversely at the same time when the lead edge of the document contacts this device or before the lead edge contacts this device. Therefore, the document is bent outwardly in the turning portion 64 and also the guide 80 swings outwardly owing to the rigidity of the document, so that an amount of deflection of the document is adjusted to apply the skew correction.

Then, the first motor 88a is rotated in the opposite direction after a predetermined time has passed, and thus the first drive roller 82a of the first carrying device 72a is rotated forwardly. Therefore, the document is put into the first nip portion 86a between the first drive roller 82a and the first driven roller 84a and carried into the reading portion 66. In this reading portion 66, the image is read at the image reading position while the document is pushed against the platen glass 68 by the read roller 70. The lead edge of the document contacts the second drive roller 82b or the second driven roller 84b in vicinity of the second nip portion 86b of the second carrying device 72b during the image reading operation, then is pushed into the second nip portion 86b, and then is carried by the second carrying device 72b. Since a work is generated to push the document when the document is pushed into the second nip portion 86b, it is possible that a change in the carrying speed of the document is caused. In particular, such speed change causes the problem in the thick paper whose weight capacity exceeds 200 g/m². However, in this embodiment, since the hardness of the surface portion of the second driven roller 84b is reduced, the document can be pushed easily into the second nip portion 86b and thus the variation of the carrying speed of the document can be reduced.

In addition, when the carrying operation of the document is still continued, the trail edge of the document exits from the first nip portion 86a of the first carrying device 72a. Also, the variation of the carrying speed of the document caused when the document exits from the first nip portion 86a creates the problem here. However, in this embodiment, since the hardness of the surface portion of the first driven roller 84a is reduced, the document can easily slip out of the first nip portion 86a and thus the variation of the carrying speed of the document can be reduced.

Then, the document is discharged onto the discharge table 59 via the discharge roller 62.

In the above embodiment, the hardness of both driven rollers in the first carrying device 72a and the second carrying device 72b is reduced lower than the hardness of the driving rollers. But the hardness may be set almost equal to each other in any one of the carrying devices. Like the above embodiment, it is preferable that, if the registration roller that is rotated reversely in the skew correction is employed as the first carrying device 72a, the Shore hardness of the surface portions of the driving roller and the driven roller based on ISO7619 should be set to 60 to 90 degree. This is because, if the hardness of the surface portion of the driven roller is small, a friction generated when the lead edge of the document comes into contact with the driven roller that is rotated reversely is enhanced to vibrate the document and thus there is such a possibility that the skew distortion is caused.

The application of the present invention is not limited to the above automatic document feeder. Also, the present invention may be applied to the above registration roller 40 (FIG. 1), for example. In other words, as shown in FIG. 7, the registration roller 40 consists of the driving roller 82 and the driven roller 84, and the surface portion of the driving roller 82 is formed of the elastic material in the EPDM type, the urethane-type, or the like, and the Shore hardness based on ISO7619 is set in a range of 60 to 90 degree. Also, the surface portion of the driven roller 84 is formed of the elastic material in the EPDM type, the urethane-type, the silicone, or the like, and the Shore hardness based on ISO7619 is set in a range of 20 to 50 degree.

The sheet fed from the registration roller 40 constructed in this fashion is passed through a space between the image bearing member 22 and the transferring device 30, and the toner image is transferred onto the sheet. Then, the trail edge of the sheet exits from the registration roller 40 during the transferring operation of the sheet. At this time, since the hardness of the surface portion of the driven roller 84 of the registration roller 40 is set low, the variation of the carrying speed of the sheet can be reduced and thus a shear of the toner image transferred onto the sheet can be reduced. For example, in some times the thick paper is fed from the manual-bypass tray 18 (FIG. 1). In such case, the variation of the carrying speed of the thick paper can be reduced and thus the further effect can be achieved.

In the above embodiments, the image bearing member 22 is formed of the photoreceptor. But the present invention is not limited to this, and also an intermediate transferring drum, an intermediate transferring belt, or the like may be employed alternately.

As described above, the present invention can be applied to the carrying apparatus that carries the sheet to the reading portion of the automatic document feeder or the transferring portion of the image forming apparatus. For this reason, the wording “acting portion” is used in claims as a generic term of the reading portion and the transferring portion.

The entire disclosure of Japanese Patent Application No. 2003-396857 filed on Nov. 27, 2003 including specification, claims, drawings and abstract is incorporated herein by reference in its entirety.

1. A sheet processing apparatus comprising:
an acting portion to exert an action on a sheet; and
at least one of a first carrying device and a second carrying device,
wherein the first carrying device is arranged on a downstream side of the acting portion, and a lead edge of the sheet enters the first carrying device during the action of the acting portion,
the second carrying device is arranged on an upstream side of the acting portion, and the sheet exits from the second carrying device during the action of the acting portion,
at least one of the first carrying device and the second carrying device has a driving roller and a driven roller, and the sheet is inserted between the driving roller and the driven roller and is carried, and
a Shore hardness Hs of at least a surface portion of the driven roller based on ISO7619 is set in a range of 20 to 50 degree.

2. A sheet processing apparatus comprising:
an acting portion to exert an action on a sheet; and
at least one of a first carrying device and a second carrying device,
wherein the first carrying device is arranged on a downstream side of the acting portion, and a lead edge of the sheet enters the first carrying device during the action of the acting portion,
the second carrying device is arranged on an upstream side of the acting portion, and the sheet exits from the second carrying device during the action of the acting portion,
at least one of the first carrying device and the second carrying device has a driving roller and a driven roller, and the sheet is put between the driving roller and the driven roller and is carried, and
a hardness of at least a surface portion of the driven roller is lower than a hardness of at least a surface portion of the driving roller.

3. The sheet processing apparatus according to claim 2,
wherein a Shore hardness Hs of the surface portion of the driving roller based on ISO7619 is set in a range of 60 to 90 degree, and
the Shore hardness Hs of the surface portion of the driven roller based on ISO7619 is set in a range of 20 to 50 degree.

4. The sheet processing apparatus according to claim 2,
wherein constitutive materials of the surface portion of the driving roller and the surface portion of the driven roller are different.

5. The sheet processing apparatus according to claim 3,
wherein constitutive materials of the surface portion of the driving roller and the surface portion of the driven roller are different.

6. A sheet processing apparatus comprising:
an acting portion to exert an action on a sheet; and
at least one of a first carrying device and a second carrying device,
wherein the first carrying device is arranged on a downstream side of the acting portion, and a lead edge of the sheet enters the first carrying device during the action of the acting portion,
the second carrying device is arranged on an upstream side of the acting portion, and the sheet exits from the second carrying device during the action of the acting portion,
at least one of the first carrying device and the second carrying device has a driving roller and a driven roller, and the sheet is put between the driving roller and the driven roller and is carried, and
a Shore hardness Hs of at least a surface portion of the driven roller based on ISO7619 is set in a range of 70 degree or less.

7. The sheet processing apparatus according to claim 6,
wherein the Shore hardness Hs of the surface portion of the driven roller based on ISO7619 is set in a range of 60 degree or less.

8. The sheet processing apparatus according to claim 6,
wherein the Shore hardness Hs of the surface portion of the driven roller based on ISO7619 is set in a range of 50 degree or less.

9. The sheet processing apparatus according to claim 6,
wherein the Shore hardness Hs of the surface portion of the driven roller based on ISO7619 is set in a range of 40 degree or less.

10. An image forming apparatus comprising a sheet processing apparatus,
wherein the sheet processing apparatus includes:
an acting portion to exert an action on a sheet; and
at least one of a first carrying device and a second carrying device,
wherein the first carrying device is arranged on a downstream side of the acting portion, and a lead edge of the sheet enters the first carrying device during the action of the acting portion,
the second carrying device is arranged on an upstream side of the acting portion, and the sheet exits from the second carrying device during the action of the acting portion,
at least one of the first carrying device and the second carrying device has a driving roller and a driven roller, and the sheet is put between the driving roller and the driven roller and is carried, and
a Shore hardness Hs of at least a surface portion of the driven roller based on ISO7619 is set in a range of 20 to 50 degree.

11. An image forming apparatus comprising a sheet processing apparatus,
wherein the sheet processing apparatus includes:
an acting portion to exert an action on a sheet; and
at least one of a first carrying device and a second carrying device,
wherein the first carrying device is arranged on a downstream side of the acting portion, and a lead edge of the sheet enters the first carrying device during the action of the acting portion,
the second carrying device is arranged on an upstream side of the acting portion, and the sheet exits from the second carrying device during the action of the acting portion,
at least one of the first carrying device and the second carrying device has a driving roller and a driven roller, and the sheet is put between the driving roller and the driven roller and is carried, and
a hardness of at least a surface portion of the driven roller is lower than a hardness of at least a surface portion of the driving roller.

12. The image forming apparatus according to claim 11,
wherein a Shore hardness Hs of the surface portion of the driving roller based on ISO7619 is set in a range of 60 to 90 degree, and
the Shore hardness Hs of the surface portion of the driven roller based on ISO7619 is set in a range of 20 to 50 degree.

13. The image forming apparatus according to claim 11,
wherein constitutive materials of the surface portion of the driving roller and the surface portion of the driven roller are different.

14. The image forming apparatus according to claim 12,
wherein constitutive materials of the surface portion of the driving roller and the surface portion of the driven roller are different.

15. An automatic document feeder comprising:
a reading portion to read an image of a document;
a first carrying device which is arranged on an upstream side of the reading portion and out of which the document slips while the reading portion reads the image of the document; and
a second carrying device which is arranged on a downstream side of the reading portion and against which the document hits while the reading portion reads the image of the document,
wherein at least one of the first carrying device and the second carrying device has a driving roller and a driven roller, and the document is put between the driving roller and the driven roller and is carried, and
a Shore hardness Hs of at least a surface portion of the driven roller based on ISO7619 is set in a range of 20 to 50 degree.

16. An automatic document feeder comprising:
a reading portion to read an image of a document;
a first carrying device which is arranged on an upstream side of the reading portion and out of which the document slips while the reading portion reads the image of the document; and
a second carrying device which is arranged on a downstream side of the reading portion and against which the document hits while the reading portion reads the image of the document,
wherein at least one of the first carrying device and the second carrying device has a driving roller and a driven roller, and the document is put between the driving roller and the driven roller and is carried, and
a hardness of at least a surface portion of the driven roller is lower than a hardness of at least a surface portion of the driving roller.

17. The automatic document feeder according to claim 16,
wherein a Shore hardness Hs of the surface portion of the driving roller based on ISO7619 is set in a range of 60 to 90 degree, and
the Shore hardness Hs of the surface portion of the driven roller based on ISO7619 is set in a range of 20 to 50 degree.

18. The automatic document feeder according to claim 16,
wherein constitutive materials of the surface portion of the driving roller and the surface portion of the driven roller are different.

19. The automatic document feeder according to claim 17,
wherein constitutive materials of the surface portion of the driving roller and the surface portion of the driven roller are different.

20. The automatic document feeder according to claim 15,
wherein a guide member to guide the document is provided in vicinity of a nip portion in which the driving roller and the driven roller face to each other, and
the guide member is formed of a sheet-like elastic body.

21. The automatic document feeder according to claim 16,
wherein a guide member to guide the document is provided in vicinity of a nip portion in which the driving roller and the driven roller face to each other, and
the guide member is formed of a sheet-like elastic body.

22. The automatic document feeder according to claim 15, further comprising:
a first driving source to drive the first carrying device; and
a second driving source provided separately from the first driving source, to drive the second carrying device.

23. The automatic document feeder according to claim 16, further comprising:
a first driving source to drive the first carrying device; and
a second driving source provided separately from the first driving source, to drive the second carrying device.

24. An image forming apparatus comprising an automatic document feeder,
wherein the automatic document feeder includes:
a reading portion to read an image of a document;
a first carrying device which is arranged on an upstream side of the reading portion and out of which the document slips while the reading portion reads the image of the document; and
a second carrying device which is arranged on a downstream side of the reading portion and against which the document hits while the reading portion reads the image of the document,
wherein at least one of the first carrying device and the second carrying device has a driving roller and a driven roller, and the document is put between the driving roller and the driven roller and is carried, and
a Shore hardness Hs of at least a surface portion of the driven roller based on ISO7619 is set in a range of 20 to 50 degree.

25. An image forming apparatus comprising an automatic document feeder;
wherein the automatic document feeder includes:
a reading portion to read an image of a document;
a first carrying device which is arranged on an upstream side of the reading portion and out of which the document slips while the reading portion reads the image of the document; and
a second carrying device which is arranged on a downstream side of the reading portion and against which the document hits while the reading portion reads the image of the document,
wherein at least one of the first carrying device and the second carrying device has a driving roller and a driven roller, and the document is put between the driving roller and the driven roller and is carried, and
a hardness of at least a surface portion of the driven roller is lower than a hardness of at least a surface portion of the driving roller.

26. The image forming apparatus according to claim 25, wherein a Shore hardness Hs of the surface portion of the driving roller based on ISO7619 is set in a range of 60 to 90 degree, and
the Shore hardness Hs of the surface portion of the driven roller based on ISO7619 is set in a range of 20 to 50 degree.

27. The image forming apparatus according to claim 25,
wherein constitutive materials of the surface portion of the driving roller and the surface portion of the driven roller are different.

28. The image forming apparatus according to claim 26,
wherein constitutive materials of the surface portion of the driving roller and the surface portion of the driven roller are different.

29. The image forming apparatus according to claim 24,
wherein a guide member to guide the document is provided in vicinity of a nip portion in which the driving roller and the driven roller face to each other, and
the guide member is formed of a sheet-like elastic body.

30. The image forming apparatus according to claim 25,
wherein a guide member to guide the document is provided in vicinity of a nip portion in which the driving roller and the driven roller face to each other, and
the guide member is formed of a sheet-like elastic body.

31. The image forming apparatus according to claim 24, further comprising:
a first driving source to drive the first carrying device; and
a second driving source provided separately from the first driving source, to drive the second carrying device.

32. The image forming apparatus according to claim 25, further comprising:
a first driving source to drive the first carrying device; and
a second driving source provided separately from the first driving source, to drive the second carrying device.

33. An image forming apparatus comprising:
an image bearing member;
a transferring device to transfer an image borne on the image bearing member onto a sheet; and
a carrying device which is arranged on an upstream side of the transferring device and out of which the sheet slips while the transferring device transfers the image,
wherein the carrying device has a driving roller and a driven roller, and the sheet is put between the driving roller and the driven roller and is carried, and
a Shore hardness Hs of at least a surface portion of the driven roller based on ISO7619 is set in a range of 20 to 50 degree.

34. An image forming apparatus comprising:
an image bearing member;
a transferring device to transfer an image borne on the image bearing member onto a sheet; and
a carrying device which is arranged on an upstream side of the transferring device and out of which the sheet slips while the transferring device transfers the image,
wherein the carrying device has a driving roller and a driven roller, and the sheet is put between the driving roller and the driven roller and is carried, and
a hardness of at least a surface portion of the driven roller is lower than a hardness of at least a surface portion of the driving roller.
